(19) United States
(12) Patent Application Publication
(10) Pub. No.: US 2004/0184407 A1
(43) Pub. Date: Sep. 23, 2004

(54) Operations, administration, and maintenance data packet and related testing methods

(75) Inventors: Chou Lan Pok, San Ramon, CA (US); Kuo-Hui Liu, San Ramon, CA (US); Chin Yuan, San Ramon, CA (US); Cheng-Hong Hu, San Ramon, CA (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/394,481

(22) Filed: Mar. 21, 2003

(51) Int. Cl. H04L 1/00

(52) U.S. Cl. 370/236

(57) ABSTRACT

The present disclosure is directed to operations, administration, and maintenance related systems and methods associated with data communications. In a particular embodiment, an encapsulated operations, administration and maintenance (OAM) data packet for use in connection with a service provider network is disclosed. The encapsulated OAM data packet includes a service provider destination address and a service provider source address. The service provider destination address is associated with a destination node within the service provider network; and the service provider source address is associated with a source node within the service provider network.

### BACKGROUND

This application relates to co-pending application Ser. No. 10/357,280 (Attorney Reference Number “1033-T00427”) filed Feb. 3, 2003, entitled ENHANCED H-VPLS SERVICE ARCHITECTURE USING CONTROL WORD, by Chenghong Hu, et. al.

This application relates to co-pending application serial no.______ (Attorney Reference Number “1033-T00439”) filed the same day as the present application, entitled ETHERNET ARCHITECTURE WITH DATA PACKET ENCAPSULATION, by Kuo-Hui Liu, et al.

### FIELD OF THE INVENTION

The present invention relates to operations, administration, and maintenance data packets and testing methods relating thereto.

### DESCRIPTION OF THE RELATED ART

Many systems and architectures have been disclosed for handling data traffic over distributed networks. One type of system that has been recently proposed to the Internet Engineering Task Force (IETF) is an Ethernet over multi-protocol label switching (MPLS) architecture.

While the proposed system has many benefits in providing cost effective data services, this system fails to adequately take into consideration operations, administration, and maintenance issues, including providing Service Provider edge-to-edge troubleshooting.

Accordingly, there is a need for improved systems and methods of providing operations, administration, and maintenance support.

### SUMMARY

The present disclosure is directed to operations, administration, and maintenance related systems and methods associated with data communications.

In a particular embodiment, an encapsulated operations, administration, and maintenance (OAM) data packet for use in connection with a service provider network is disclosed. The encapsulated OAM data packet includes a service provider destination address and a service provider source address. The service provider destination address is associated with a destination node within the service provider network; and the service provider source address is associated with a source node within the service provider network.

In another embodiment, an operations, administration, and maintenance (OAM) data packet for use in a distributed computer network is disclosed. The OAM data packet includes a service provider destination field including a multi-cast value indicating a multi-cast packet that is to be multicast to a plurality of nodes within the distributed computer network; a service provider source address, and an Ethertype field including an additional value indicating an OAM packet type. The service provider source address is associated with a unique source node within the distributed computer network.

In another embodiment, a method of performing a point to point connectivity test from a source node to a destination node within a distributed computer network is disclosed. The method includes generating a unicast OAM packet, the unicast OAM packet including a service provider destination address, the destination address associated with the destination node within the distributed computer network, and a service provider source address. The service provider source address is associated with the source node within the distributed computer network. The method further includes communicating the unicast OAM packet from the source node to the destination node of the distributed computer network.

In another embodiment, the method includes generating a multi-cast OAM packet, the multi-cast OAM packet including a service provide source address, and communicating the multi-cast OAM packet from the source node to the plurality of destination nodes of the distributed computer network. The source address is associated with the source node within the distributed computer network;

In another embodiment an operations, administration, and maintenance (OAM) data packet for use in a bridged Ethernet distributed computer network is disclosed. The OAM data packet includes a service provider destination address, the destination address associated with a destination node within the bridged Ethernet distributed computer network; a service provide source address, and an Ethertype field including a value indicating an OAM packet type. The source address is associated with a source node within the bridged Ethernet distributed computer network;

In another embodiment, a method of testing data communication within a network is disclosed. The method includes generating a testing packet for communication by a multi-tenant unit; and communicating the testing packet from the multi-tenant unit to another element within the network, the testing packet including an address associated with a site in communication with the multi-tenant unit.

In another embodiment, a method of providing data communications network operations and maintenance functions is disclosed. The method includes encapsulating an OAM data packet within one of a control word and a medium access control packet within the data communications network; communicating the OAM data packet within the data communications network; and providing a network operations and maintenance function based the communication of the OAM data packet.

### BRIEF DESCRIPTION OF THE DRAWINGS

FIG. 1 is a block diagram that illustrates a particular system architecture that provides Ethernet over IP/MPLS.

FIG. 2 is a block diagram that illustrates another system architecture that provides Ethernet over IP/MPLS.

FIG. 3 illustrates an example of an operations, administration, and maintenance (OAM) packet with MAC-in-MAC encapsulation.

FIG. 4 illustrates another example of an operations, administration, and maintenance (OAM) packet with MAC-in-MAC encapsulation.

FIG. 5 is a flow diagram illustrating a method of performing OAM packet handling at an ingress point for MAC-in-MAC mode.

FIG. 6 is a flow diagram illustrating a method of packet handling at an egress point for MAC-in-MAC mode.

FIG. 7 illustrates an example of a customer packet that can be used where the control word is defined.

FIG. 8 is a flow diagram illustrating a method for OAM packet handling at an ingress point using a control word mode.

FIG. 9 is a flow diagram illustrating a method for handling packets at an egress point using a control word mode.

The use of the same reference symbols in different drawings indicates similar or identical items.

### DESCRIPTION OF THE EMBODIMENT(S)

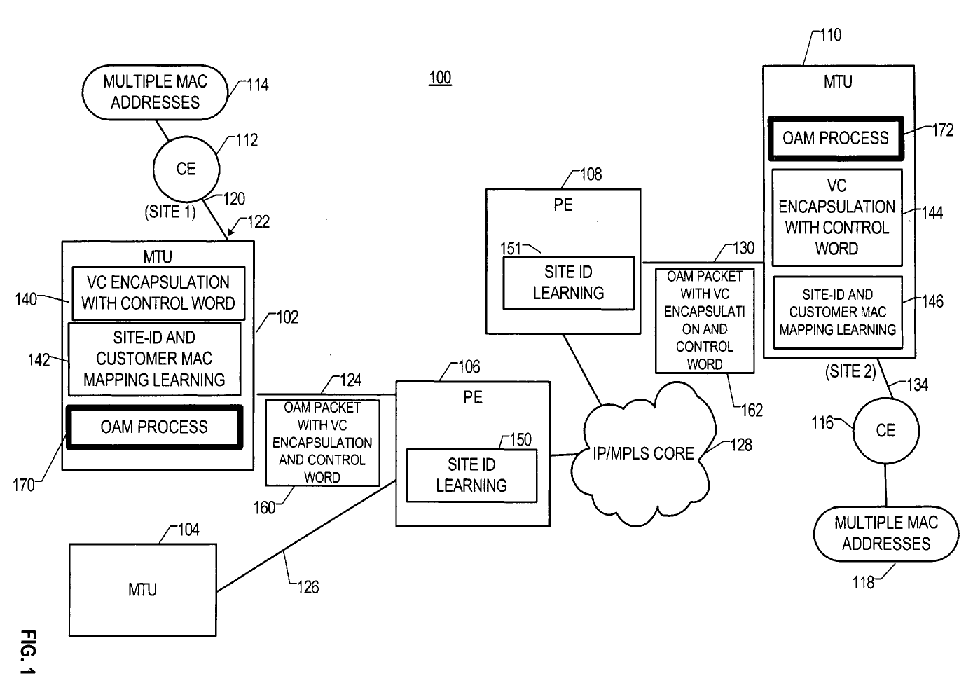

Referring to FIG. 1, a system 100 is disclosed. The system 100 includes customer equipment 112, multi-tenant unit (MTU) 102, provider edge equipment unit 106, a second provider edge equipment unit 108, internet protocol/multi-protocol label switching core (IP/MPLS) 128, a destination multi-tenant unit 110, and destination customer equipment 116. The customer equipment 112 is located at a first site and is associated with a plurality of modem access control (MAC) addresses 114. The customer equipment 112 at the first site is linked to the MTU 102 via link 120. Data communicated between the CE 112 and the MTU 102 is received at a first port 122 of the MTU 102. The MTU 102 includes a virtual circuit (VC) encapsulation with control word module 140, a site-ID and customer MAC mapping learning module 142, and an OAM process 170. The provider edge equipment 106 includes site identification learning module 150 and is coupled to another MTU 104 via virtual circuit 126. The first provider edge equipment unit 106 is in communication with the first MTU 102 via virtual circuit 124.

The second provider edge equipment unit 108 also includes a site identification learning module 151 and is coupled to MTU 110 via virtual circuit 130. The MTU 110 includes a site identification and customer MAC mapping learning module 146 and VC encapsulation with control word module 144. The MTU 110 is coupled to customer equipment 116 via data link 134. The customer equipment 116 is located at a second site and is associated with a second plurality of MAC addresses 118.

During operation, data packets originating from the customer equipment 112 at the first site are communicated over data link 120 and the first port 122 to the MTU 102. At the MTU 102, a site identification for the first site of the customer equipment 112 is associated with a plurality of MAC addresses for such customer equipment. In addition, the MTU 102 performs MAC mapping learning 142. The OAM process 170 in MTU 102 generates OAM packet 160. The OAM packet 160 with VC encapsulation and control word is destined to MTU 110. The control word in OAM packet 160 includes the destination site identification (ID) and the source site identification (ID) associated with the first site where the customer equipment 112 is located. Similarly, the destination site ID is associated with the destination site, such as the second site where the customer equipment 116 is located.

The provider edge equipment 106, responsive to receipt of OAM packet 160, receives the site ID information, performs site ID learning via module 150, and determines the destination ID for further routing of the packet. Data packets are forwarded by the provider edge equipment 106 via the IP/MPLS core network 128 to far end provider edge equipment, such as provider edge equipment 108. The provider edge equipment 108 further passes an OAM packet 162 with VC encapsulated control: word containing the destination site ID via virtual circuit 130 to the MTU 110. The OAM packet 162 with VC encapsulated control word is processed at the MTU 110. The source site ID, destination site ID, and MAC mapping learning processes 146 and the OAM process 172 are performed and the OAM packet has reached its destination. A service provider OAM packet, unlike a customer data packet, will not be routed and forwarded to the customer equipment.

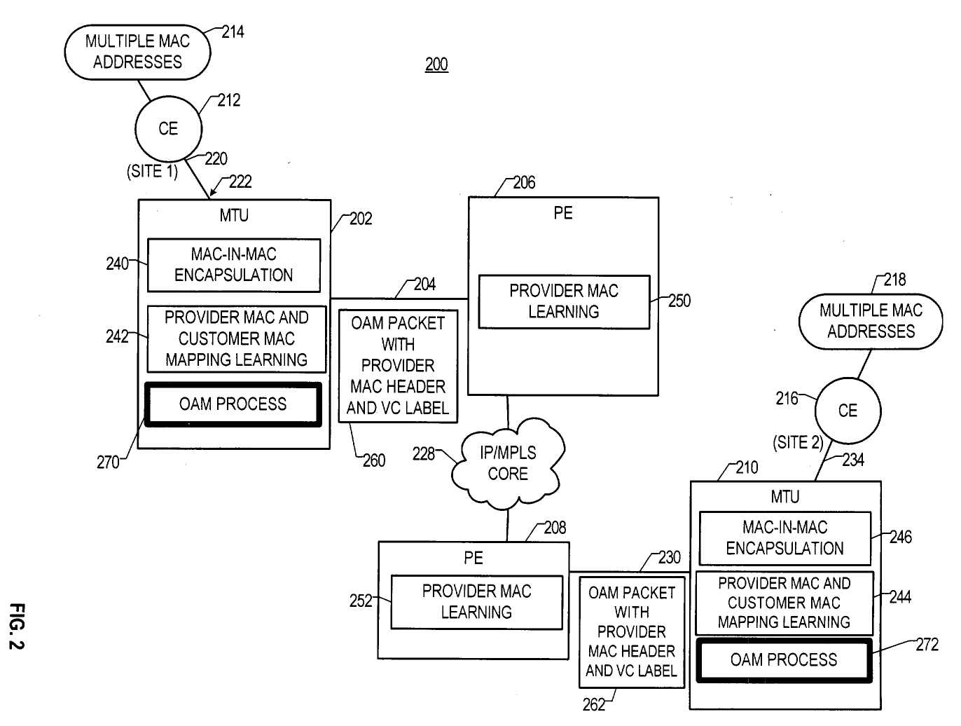

Referring to FIG. 2, another embodiment of a system 200 is shown. The system 200 includes customer equipment at a first site 212 and at a second site 216. The system 200 also includes MTUs 202 and 210 and provider edge equipment (PE) 206 and 208. The system 200 includes an IP/MPLS core 228 between the PE 206 and the PE 208. The MTU 202 is linked to the PE 206 via virtual circuit 204 and the PE 208 is linked to MTU 210 via virtual circuit 230. The customer equipment 212 at the first site is associated with a plurality of MAC addresses 214 and the customer equipment at the second site 216 is associated with a second plurality of MAC addresses 218. The MTU 202 includes a communication port 222, a MAC-in-MAC encapsulation module 240, and a provider MAC and customer MAC mapping learning module 242. The MTU 202 further includes the OAM process 270. The MTU 202, upon receiving service operator commands, creates an OAM packet 260 with a provider MAC header and a VC label. The OAM packet 260 is destined to the second site in MTU 210. The OAM packet 260 is then communicated via virtual circuit 204 to the provider edge equipment 206.

PE 206 includes provider MAC learning module 250 for receiving and processing logical port addresses (also referred to as service provider MAC addresses), such as those within the data packet 260. Similarly, PE 208 includes logical port-based MAC learning module 252. Communication of the OAM packet 262 with logical port addresses is made over a virtual circuit 230 to the MTU 210. MTU 210 includes MAC-in-MAC encapsulation module 246, provider MAC and customer MAC mapping learning module 244, and the OAM process 272. During OAM operation, the operator in the service provider company, issues commands to MTU 202 to monitor or troubleshoot the service from site 1 to site 2 or from site 1 to other sites. Triggered by the operator commands, an OAM packet is generated by the OAM process 270, the source and destination logical port addresses are determined in process 242 and the MAC in MAC header is created in process 240 within MTU 202. The MTU 202 communicates the OAM packet to the PE 206. PE 206 performs provider MAC learning, communicates the OAM packet similarly as a data packet over the IP/MPLS core 228, and the OAM packet is received at PE 208. PE 208 forwards the OAM packet to destination MTU 210, which processes the OAM packet with OAM process 272. A service provider OAM packet is not forwarded to customer equipment.

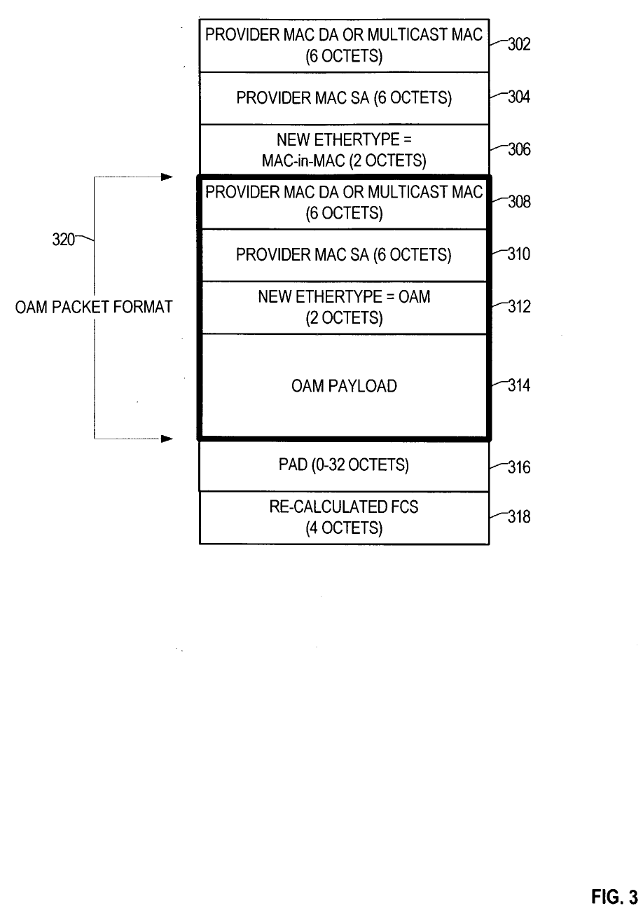

FIG. 3 illustrates an example of an OAM packet with MAC-in-MAC encapsulation in a bridge mode. For purposes of illustration, in the present example, while specific lengths and number of fields are described, one skilled in art will appreciate that any number of fields with any lengths (e.g. jumbo frames or the like) can be used as defined and supported by the protocols employed in the networks. The number and description of fields in the header can be configured in any order or combination thereof according to the specific network requirements.

Fields 302 and 304 are each six octets wide. The encapsulation of fields 302 and 304 depends on the type of customer device. For customers that interface with bridging devices, the provider MAC DA and provider MAC SA fields are populated with the provider MAC addresses. For customers that interface with routing devices, the provider MAC DA and provider MAC SA fields are encapsulated with the customer router addresses. Field 306 is two octets wide and defines the new Ethertype as a MAC-in-MAC packet.

Field 312 is two octets wide and defines the Ethertype as OAM. Field 314 defines an OAM payload value and field 316 is a padding field. Field 318 is four octets wide and defines a re-calculated frame check sequence (FCS) for the MAC-in-MAC OAM frame.

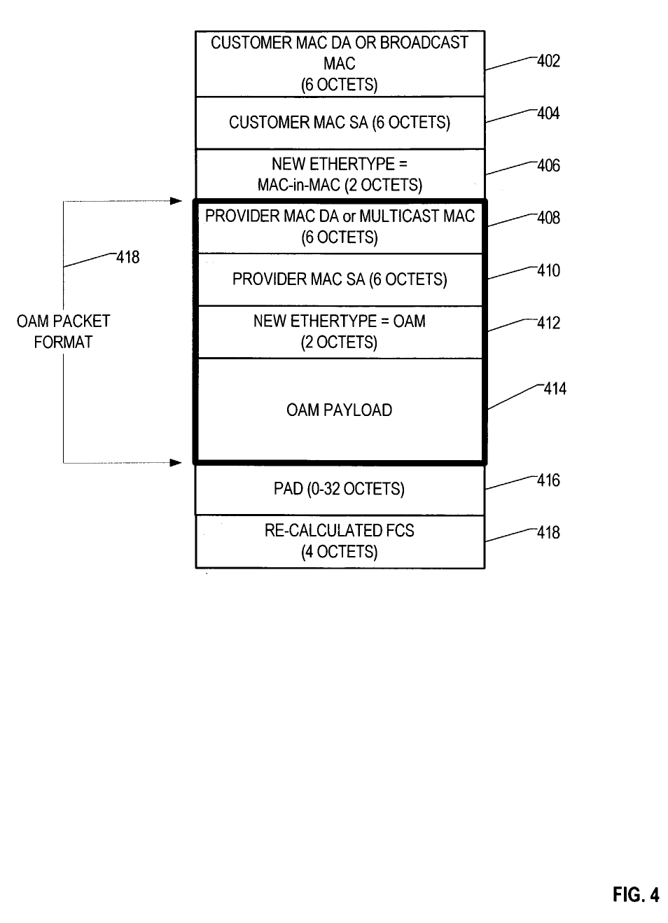

FIG. 4 illustrates another example of an OAM packet format with MAC-in-MAC encapsulation in router mode. Fields 402 and 404 are each six octets wide. For customers that interface with routing devices, the MAC DA and MAC SA fields are encapsulated with the customer router addresses. Field 406 is two octets wide and defines the Ethertype as a MAC-in-MAC packet. Field 408 is a provider MAC destination address or a multicast MAC. Field 410 is the provider MAC source address.

Field 412 is two octets wide and defines the Ethertype as OAM. Field 414 defines an OAM Payload. Field 416 is a padding field. Field 418 is four octets wide and defines a frame check sequence (FCS) for the MAC-in-MAC OAM frame. The FCS is re-calculated to include newly defined field.

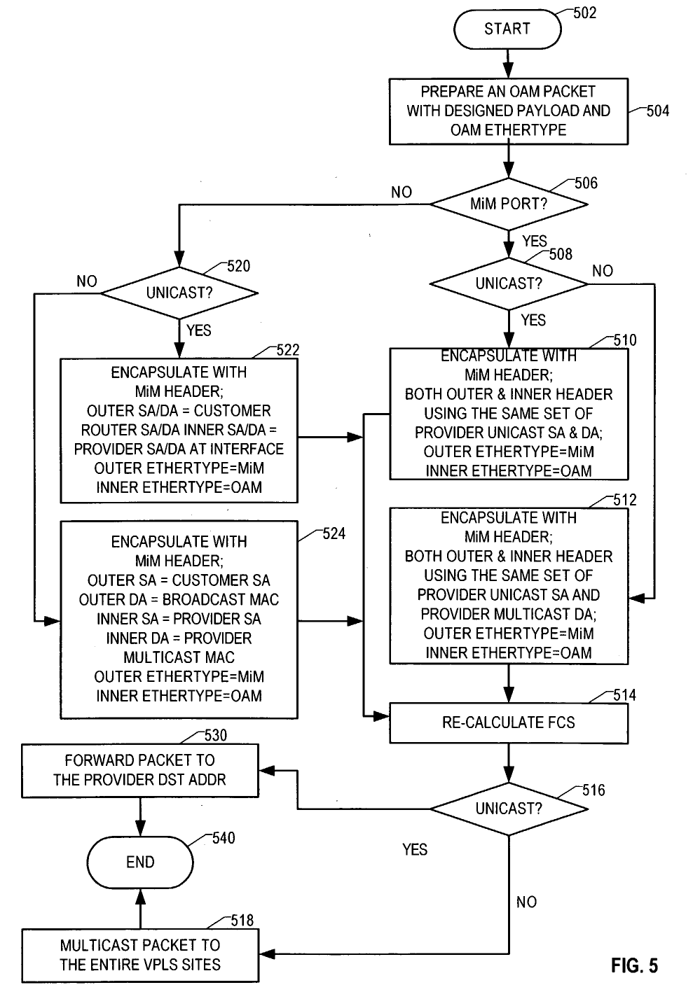

Referring to FIG. 5, a method of performing OAM packet handling at an ingress point for MAC-in-MAC mode is disclosed. An OAM packet is prepared with a design payload and OAM Ethertype at 504. At 506, a determination of whether the port is a MiM port is made. If the port is a MiM port, then the unicast determination is made at 508. If the unicast determination is positive, then the packet is encapsulated with an MiM header, both outer and inner header using the same set of provider unicast source address and destination address, the outer header Ethertype is set to MiM and the inner Ethertype is set equal to OAM, at step 510. In this case, processing then continues to where the FCS is recalculated, at 514.

Referring again to decision block 508, if the unicast determination is “no”, then the packet is encapsulated with a MiM header, the outer and inner header uses the same set of provider unicast source address and provider multicast destination address, the outer header Ethertype is equal to MiM, and the inner Ethertype is set to OAM, all performed at 512. Processing then continues where the FCS is recalculated at 514. In either case, after recalculating the FCS, at 514, another unicast determination is made, at 516. In the unicast situation, the packet is forwarded to the provider destination address, at 530, and processing ends, at 540. Where the unicast determination is negative, then a multicast packet is broadcast to the entire VPLS network of sites, at 518, and processing ends at 540.

Referring to MiM port decision block 506, where a MiM port is not detected, then a unicast determination is made at decision step 520. Where a unicast packet is detected, the packet is encapsulated with the MiM header, the outer source address/destination address is set to the customer router source and destination address, inner source address and destination address is set equal to provider source address and destination address at interface, the outer Ethertype is set equal to MiM and the inner Ethertype is set equal to OAM, all as described in processing step 522. Where the unicast determination is negative, at 520, then the packet is encapsulated with a MiM header, the outer source address is set equal to the customer source address, the outer destination address is set equal to broadcast MAC, the inner source address equals the provider source address, the inner destination address equals provider multicast MAC, the outer Ethertype is set equal to MiM, and the inner Ethertype is set equal to OAM, all as described in processing step 524. In either case, following packet encapsulation, at 522 or 524, processing is directed to step 514 where the FCS is recalculated. At this point in the method, processing continues at unicast decision step 516 as described above.

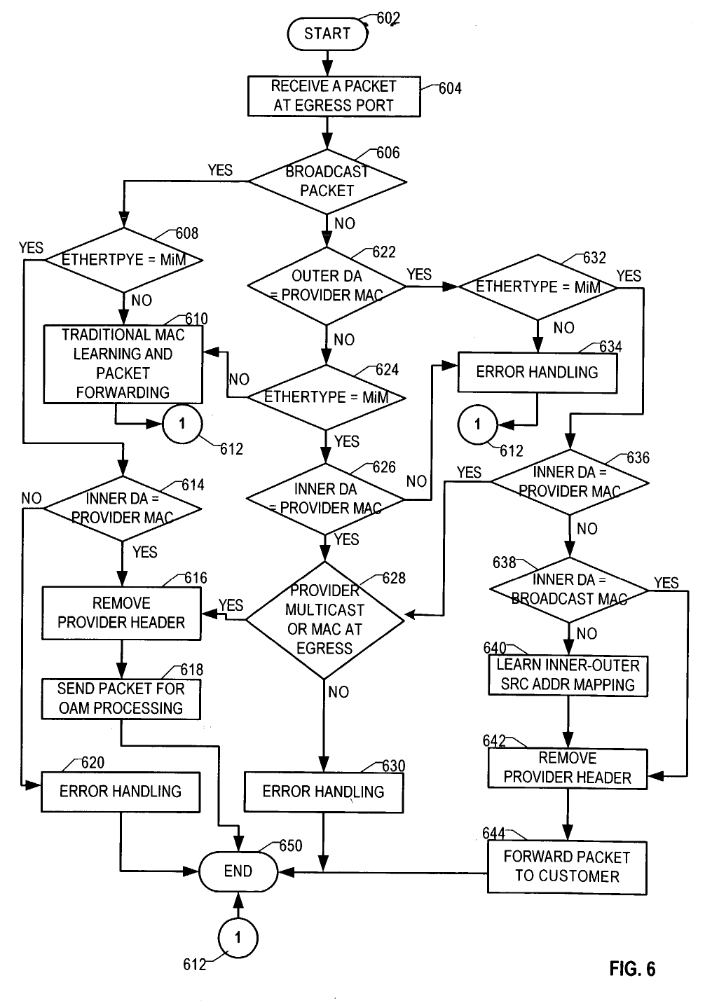

Referring to FIG. 6, a method of packet handling at an egress point for MAC-in-MAC mode is disclosed. A packet to be analyzed is received at an egress port at 604. At decision step 606, a determination is made whether the packet is for broadcast. If a broadcast packet is detected, then decision step 608 is evaluated to determine whether the Ethertype is equal to MiM. If the Ethertype is not determined to be set equal to MiM, then traditional MAC learning and packet forwarding, is executed at 610 and processing then continues to logic flow marker 1, at 612, and to the end of processing, at 650.

Referring back to decision step 608, if the Ethertype is equal to MiM, then a determination is made whether the inner destination address is equal to the provider MAC, at decision step 614. Where this determination is positive then the provider header is removed, at 616, the packet for OAM processing is sent, at 618, and processing ends at step 650. In the case where the inner destination address is not equal to the provider MAC, then an error handling routine is performed at 620 and processing ends at 650.

Referring again to decision step 606, if the broadcast packet determination is negative, then at decision step 622, the outer destination address is compared to the provider MAC. If the outer destination address equals the provider MAC, then a determination is made regarding the Ethertype, at decision step 632. If the Ethertype is not equal to the MiM at 632, then an error is detected and error handling is performed at 634, leading to the end of processing at 612, 650. Where the Ethertype is equal to MiM, at 632, then the inner destination address is compared to the provider MAC, at decision step 636. Where the inner destination address is not equal to the provider-MAC, then the inner destination address is compared to the broadcast MAC, at decision step 638. Where this decision is negative, processing continues at 640, where the inner and outer source address mapping is learned and where the provider header is removed, at 642. Where the inner destination address is equal to the broadcast MAC, at decision step 638, then processing is continued where the provider header is removed, at 642. In either situation, the packet is forwarded to the customer, at 644 and processing is completed at 650.

Referring again to decision step 622, where the outer destination address is not equal to the provider MAC, then a determination is made, at decision step 624, whether the Ethertype is equal to MiM. Where the Ethertype is not equal to MiM, then processing continues from decision step 624 to processing step 610 as described above. Where the Ethertype is equal to MiM, then a determination is made at decision step 626, whether the inner destination address equals the provider MAC. Where the inner destination address does not equal the provider MAC, then an error is detected and error handling is performed at 632 and processing is completed at 612, 650. Where the inner destination address does equal the provider MAC, then a determination is made, at decision step 628, regarding multicast. Where a provider multicast or MAC at egress situation is detected at 628, then processing at this point continues to step 616 as described above. In the case where the provider multicast or MAC at egress at 628 determination is negative, then an error is detected and error handling is performed at 630 eventually leading to completion of processing at 650.

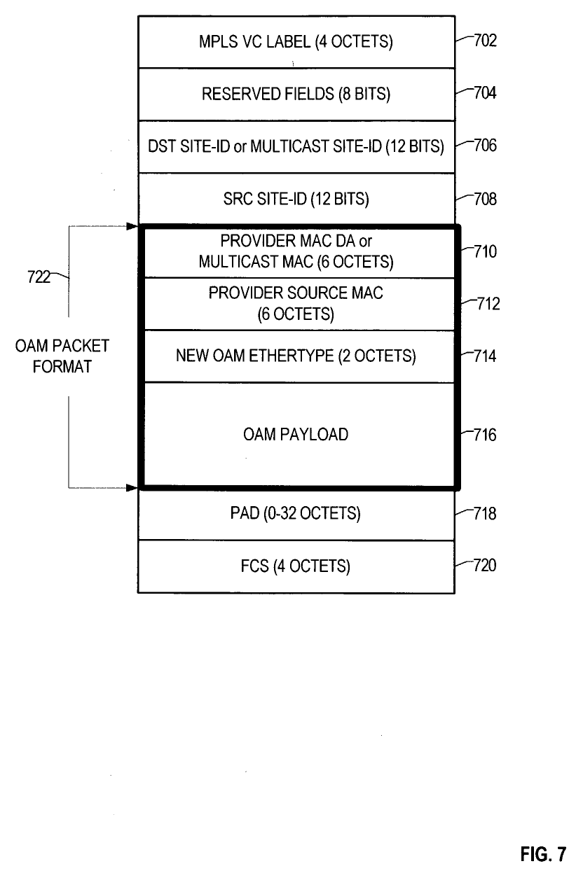

FIG. 7 illustrates an example of a customer packet header that can be used where the control word is defined. Field 702 is for the MPLS VC label and is four octets. Field 704 is reserved and is eight bits. Field 706 is twelve bits for the destination or Multicast site IDs. Field 708 is for the source site ID and is also twelve bits. The illustrated data packet also includes provider destination MAC address or multicast MAC 710, provider source MAC address 712, new OAM Ethertype 714, OAM payload 716, pad 718, and original FCS 720.

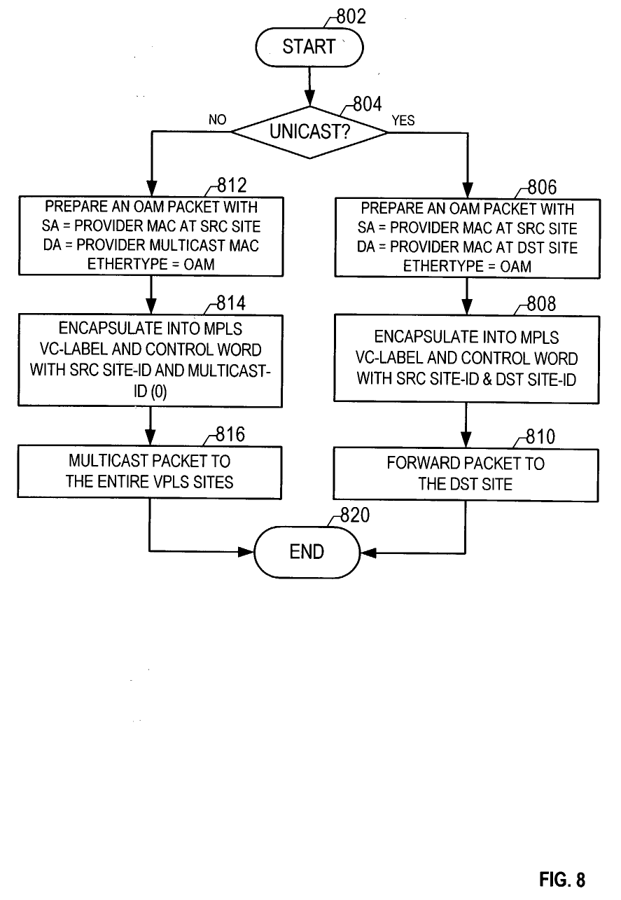

Referring to FIG. 8, a method for OAM packet creation at an ingress point for a control word is illustrated. For this method, processing begins at step 802, and a unicast OAM packet determination is made, at step 804. Where a unicast packet is not detected at 804, then an OAM packet is prepared with the source address set equal to the provider MAC at a source site, the destination address set equal to the provider multicast MAC, and the Ethertype is set equal to OAM, all at processing step 812. The OAM packet is encapsulated into an MPLS frame where the VC-label and control word is based on the source site ID and uses a unique multicast ID, at process step 814. The packet is then multicast over a broadcast network to the entire set of VPLS sites, at 816. Processing is then completed at 820.

Referring again to decision step 804, where a unicast mode is detected, processing proceeds to step 806. At this step, an OAM packet is prepared that has the source address equal to the provider MAC and the source site, a destination address set equal to the provider MAC at the destination site, an Ethertype equal to OAM. Next, the packet is encapsulated into an MPLS frame, where the VC label is determined and a control word is set based on the source site ID and the destination site ID, at 808. The packet has been formulated and framed and is then forwarded to the destination site, at 810, and processing is completed at 820.

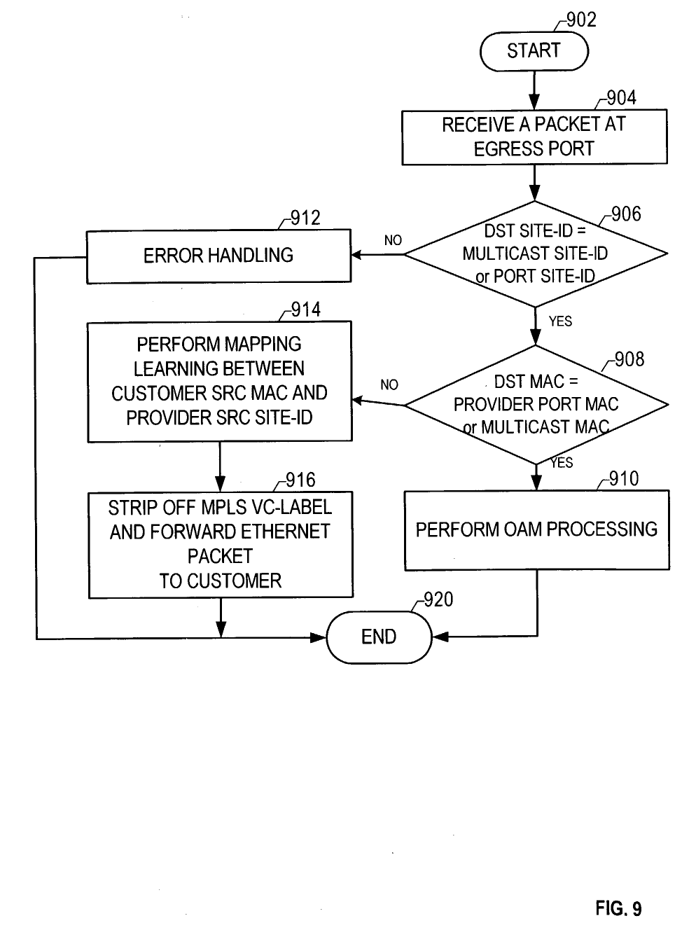

Referring to FIG. 9, a method for handling packets at an egress point using a control word mode is illustrated. A packet is received at an egress port, at 904. The destination site is checked at 906. If the destination site is not equal to the multicast site ID or the port site ID, at decision step 906, then error handling is performed at 912 and processing is completed at 920. If the destination site is equal to the multicast site ID or port site ID, as determined at decision step 906, then the destination MAC is compared to the provider port MAC or the multicast MAC, at decision step 908. Where the destination MAC equals either the provider port MAC or the multicast MAC, then OAM processing is performed at 910 and the method is completed at 920. Where the destination MAC is not equal to the provider MAC or multicast MAC, then the method performs learning and mapping between the customer source MAC and the provider site ID, at 914, thereafter, the MPLS VC-label is stripped off, and the Ethernet packet is forwarded to the customer at 916. Processing is then completed at 920.

The above disclosed subject matter is to be considered illustrative and the appended claims are intended to cover all such modifications and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An encapsulated operations, administration and maintenance (OAM) data packet for use in connection with a service provider network, the encapsulated OAM data packet comprising:
a service provider destination address, the service provider destination address associated with a destination node within the service provider network; and
a service provider source address, the service provider source address associated with a source node within the service provider network.

2. The data packet of claim 1, further comprising an Ethertype field having a value for OAM.

3. An operations, administration and maintenance (OAM) data packet for use in a distributed computer network, the OAM data packet comprising:
a service provider destination field including a multi-cast value indicating a multi-cast packet that is to be multicast to a plurality of nodes within the distributed computer network;
a service provider source address, the source address associated with a unique source node within the distributed computer network; and
an Ethertype field including an additional value indicating an OAM packet type.

4. A method of performing a point to point connectivity test from a source node to a destination node within a distributed computer network, the method comprising:
generating a unicast OAM packet, the unicast OAM packet including a service provider destination address, the destination address associated with the destination node within the distributed computer network and
a service provider source address, the source address associated with the source node within the distributed computer network; and
communicating the unicast OAM packet from the source node to the destination node of the distributed computer network.

5. The method of claim 4, further comprising determining a performance measurement using the communication of the unicast OAM packet within the distributed computer network.

6. A method of performing a point to multi-point connectivity test from a source node to a plurality of destination nodes within a distributed computer network, the method comprising:
generating a multi-cast OAM packet, the multi-cast OAM packet including
a service provide source address, the source address associated with the source node within the distributed computer network; and
communicating the multi-cast OAM packet from the source node to the plurality of destination nodes of the distributed computer network.

7. The method of claim 6, further comprising determining a performance measurement using the communication of the multi-cast OAM packet within the distributed computer network.

8. An OAM data packet for use in connection with a distributed computer network, the OAM data packet comprising:
a network header portion, the network header portion including:
a network destination address, the network destination address associated with a destination node within the distributed computer network, or a broadcast address;
a network source address, the source address associated with a source node within the distributed computer network;
an OAM header portion, the OAM header portion including:
a service provider destination address, wherein the destination address is associated with a destination node within the distributed computer network or wherein the destination address is a multicast address associated with a group of nodes in the distributed computer network;
a service provider source address, the source address associated with a source node within the distributed computer network; and
an OAM packet payload value.

9. The data packet of claim 8, wherein the OAM header further includes an new Ethertype field value to indicate an OAM packet.

10. An operations, administration and maintenance (OAM) data packet for use in a bridged Ethernet distributed computer network, the OAM data packet comprising:
a service provider destination address, the destination address associated with a destination node within the bridged Ethernet distributed computer network;
a service provide source address, the source address associated with a source node within the bridged Ethernet distributed computer network; and
an Ethertype field including a value indicating an OAM packet type.

11. A data packet for use in connection with a distributed computer network, the distributed computer network including a first multi-tenant unit and a second multi-tenant unit, the data packet comprising:
a network header portion, the network header portion including:
a network destination address, the network destination address associated with a destination node within the distributed computer network, the destination node comprising the second multi-tenant unit;
a network source address, the source address associated with a source node within the distributed computer network, the-source node comprising the first multi-tenant unit;
an OAM header portion, the OAM header portion including:
a service provider destination address, the destination address associated with a destination node within the distributed computer network, the destination node comprising the second multi-tenant unit;
a service provider source address, the source address associated with a source node within the distributed computer network, the source node comprising the first multi-tenant unit; and
an OAM data packet payload value.

12. A method of communicating a data packet from a first multi-tenant unit to a second multi-tenant unit within a distributed computer network, the method comprising:
generating the data packet, the data packet including:
a network header portion, the network header portion including:
a network destination address, the network destination address associated with a destination node within the distributed computer network, the destination node comprising the second multi-tenant unit;
a network source address, the source address associated with a source node within the distributed computer network, the source node comprising the first multi-tenant unit;
an OAM header portion, the OAM header portion including:
a service provider destination address, the destination address associated with a destination node within the distributed computer network, the destination node comprising the second multi-tenant unit;
a service provider source address, the source address associated with a source node within the distributed computer network, the source node comprising the first multi-tenant unit; and
an OAM data packet payload value; and
communicating the data packet from the first multi-tenant unit to the second multi-tenant unit, via the distributed computer network.

13. A method of testing data communication within a network, the method comprising:
generating a testing packet for communication by a multi-tenant unit; and
communicating the testing packet from the multi-tenant unit to another element within the network, the testing packet including an address, the address associated with a site in communication with the multi-tenant unit.

14. The method of claim 13, wherein the testing packet includes a data field that identifies the OAM function.

15. The method of claim 13, further comprising providing a trace-route function in response to detecting communication of the testing packet between a plurality of elements within the network.

16. The method of claim 13, wherein the site is further associated with a plurality of medium access control (MAC) addresses.

17. The method of claim 13, wherein the testing packet is communicated from the multi-tenant unit, via a multi-protocol label switching data network, to a destination multi-tenant unit.

18. The method of claim 13, wherein the testing packet is an OAM data packet.

19. A method of providing data communications network operations and maintenance functions, the method comprising:
encapsulating an OAM data packet within one of a control word and a medium access control packet within the data communications network;
communicating the OAM data packet within the data communications network;
providing a network operations and maintenance function based the communication of the OAM data packet.

20. The method of claim 19, wherein the network operations and maintenance function is selected from a connection verification function, a trouble-shooting function, a network performance function, and a measurement function.

21. The method of claim 19, wherein the OAM data packet is communicated to various network elements within a virtual private network (VPN) service domain.

22. The method of claim 19, wherein the OAM data packet is one of a multicast packet and a unicast packet.
